(19) United States
(12) Patent Application Publication
(10) Pub. No.: US 2013/0048802 A1
(43) Pub. Date: Feb. 28, 2013

(54) DISPLAY STAND FOR TABLET COMPUTER OR THE LIKE

(71) Applicant: Iles Z. Guran, Elmira (CA)

(72) Inventor: Iles Z. Guran, Elmira (CA)

(73) Assignee: Bonzai Design Group Inc., Elmira (CA)

(21) Appl. No.: 13/591,548

(22) Filed: Aug. 22, 2012

Related U.S. Application Data
(60) Provisional application No. 61/529,863, filed on Aug. 31, 2011.

(51) Int. Cl. F16M 11/06; F16M 11/24

(52) U.S. Cl. 248/122.1; 248/121; 248/125.8

(57) ABSTRACT

The display stand assembly for a tablet computer or the like has a support structure and a device-holding assembly secured to the support structure. The device-holding assembly includes a housing having a rear surface and surrounding walls extending therefrom, defining an insert cavity sized larger than the device. At least one replaceable insert is positionable within the insert cavity and defines a device cavity sized to receive the device. A face plate with an optional separate frame is securable to the housing over the insert(s) and device, to secure the device and show the display screen while denying physical access to parts of the device.

### REFERENCE TO RELATED APPLICATION(S)

This application is a formal application based on and claiming the benefit of provisional application Ser. No. 61/529,863, filed Aug. 31, 2011.

### BACKGROUND OF THE INVENTION

This invention relates to display stands, and particularly to display stands for tablet computers, electronic touchpads or other electronic tablet, electronic book, handheld or multimedia device. For convenience, such devices will be generally referred to as electronic display devices.

Often, it is desirable to provide people with access to certain functions of a tablet computer, for example, but without giving them access to all functions of the device. For example, at a trade show, it may be desirable to allow visitors to select certain information to be displayed, but undesirable to permit them to turn the device off, or switch to unauthorized functions. Physically blocking access to parts of the device is often the most desirable solution.

An Apple iPad, for example, has a touch-responsive display surrounded by a frame. The frame has a single control or “home” button. Blocking or restricting physical access to that home button may be desired. (The iPad also permits access to certain control functions via certain finger-swipe gestures, but those can be disabled.) The iPad, and other devices, may also have one or more camera lenses, which it may or may not be desirable to cover, depending on the application.

It is also necessary or at least highly desirable to provide physical security for the device, so that it cannot be easily stolen.

It is also desirable for the display stand to be relatively light in weight, and capable of being disassembled for easy portability and shipment.

It is also preferable in many situations to be able to use the display stand in more than a single configuration.

Finally, it is desirable to be able to use the display stand with a variety of devices, including (without limitation), iPad tablets, Samsung Galaxy tablets, Motorola Zoom tablets and Blackberry Playbook tablets.

### BRIEF SUMMARY OF THE INVENTION

In view of the preceding, it is a goal of the invention to provide a display stand assembly which responds to some or all of the above objectives.

The invention therefore provides a display stand assembly for a tablet computer or other device having an electronic display area. The display stand assembly has a support structure and a device-holding assembly secured to the support structure. The device-holding assembly includes a housing having a rear surface and surrounding walls extending therefrom, defining an insert cavity sized larger than the device, at least one replaceable insert positionable within the insert cavity and defining a device cavity sized to receive the device, and a face plate securable to the housing over the insert(s) and device, the face plate having an opening sufficiently large to expose the display area of the device. This configuration allows devices of different sizes to be used in the display stand assembly by selection of insert(s) defining a device cavity appropriately sized for the selected device.

Preferably, the display stand assembly also includes a frame positioned between the face plate and the housing to overlie the device, having an opening sufficiently large to expose the display area of the device. This allows for one size of face plate opening for a wide variety of devices, by providing device-specific kits having suitably-configured insert(s) and a frame with an appropriately-sized opening for the device. This is especially advantageous since a variety of frames can be provided much less inexpensively than a variety of face plates, since they can be much less robust (a thin sheet of plastic for example), with no complex machining or molds required. For devices of different sizes, kits can be provided which consist simply of the appropriate inserts, and an appropriate frame or frames. (It may be desirable to provide more than one frame for a given device, to provide flexibility as to which features of the device are to be covered and which are to be revealed.)

There can be one, two or more inserts to define the device cavity. Having four inserts is optimal in terms of maximum flexibility, lower material cost, and maximum internal space for cable routing, etc.

In its preferred embodiment, the unit is configurable in three ways (floor display, table-top display and wall display).

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is a perspective view of an example of a floor display configuration of the invention;

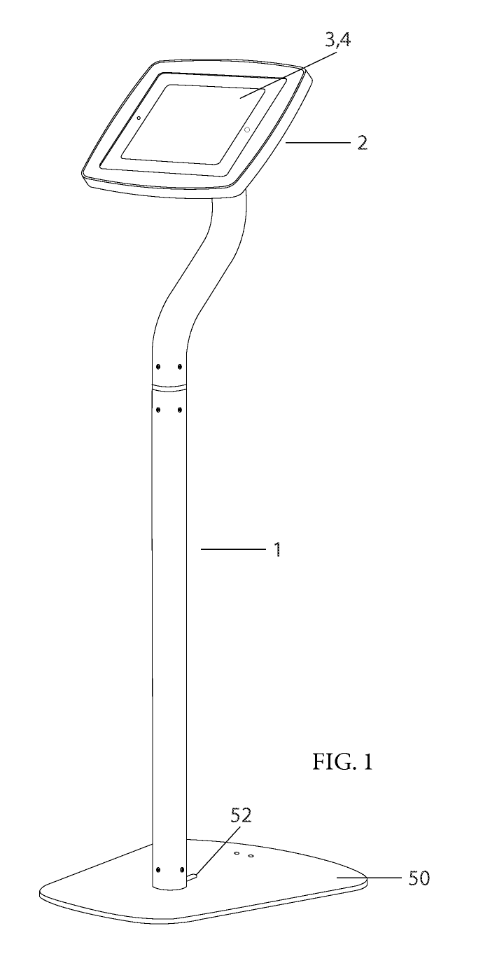

FIG. 2 is an exploded perspective view corresponding to FIG. 1;

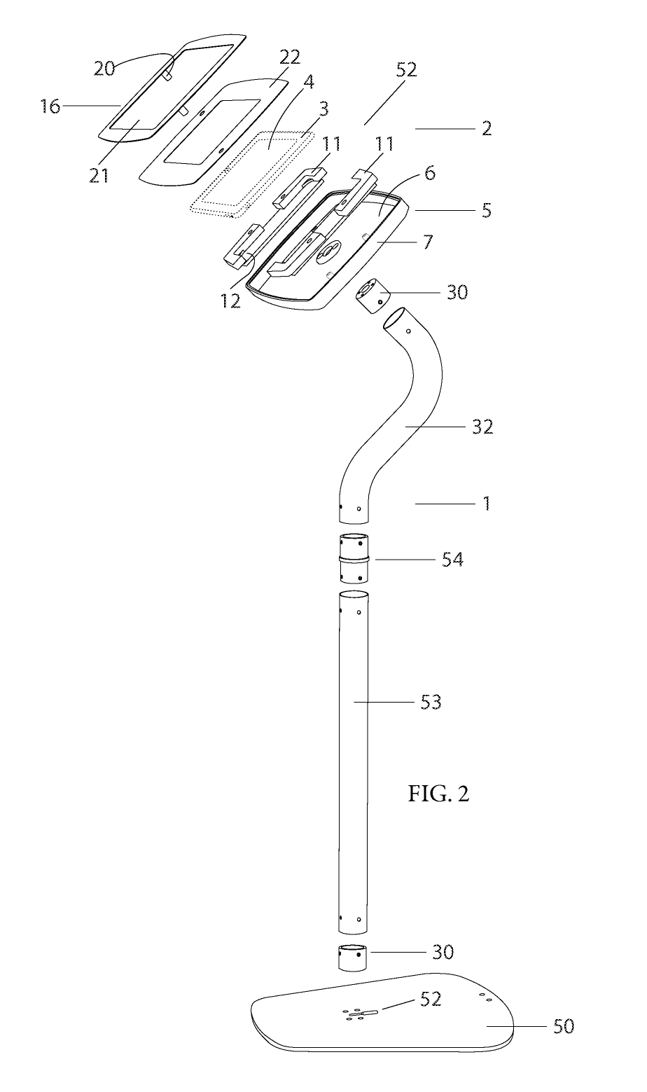

FIG. 3 is an exploded perspective view of the device-holding assembly of FIG. 1;

FIG. 4 is an exploded perspective view showing an alternative insert configuration, namely a one-piece insert;

FIG. 5 is an exploded perspective view showing another alternative insert configuration, using four inserts;

FIG. 6 is a perspective view of a connector;

FIG. 7 is a rear perspective view of an embodiment with a ball joint between the support structure and the device-holding assembly;

FIG. 8 is a perspective view of an example of a table-top configuration;

FIG. 9 is an exploded perspective view of a double-ended connector between two tubing sections; and

FIG. 10 is a perspective view of an example of a wall mount configuration.

### DETAILED DESCRIPTION OF THE INVENTION

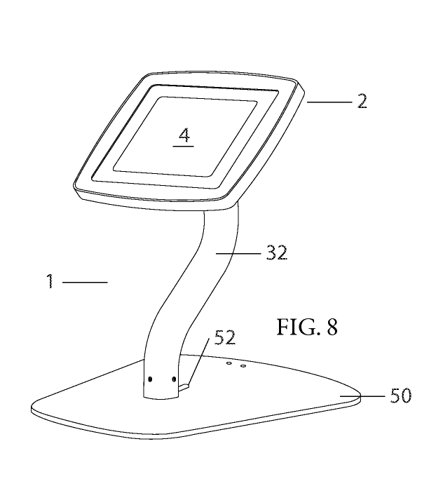

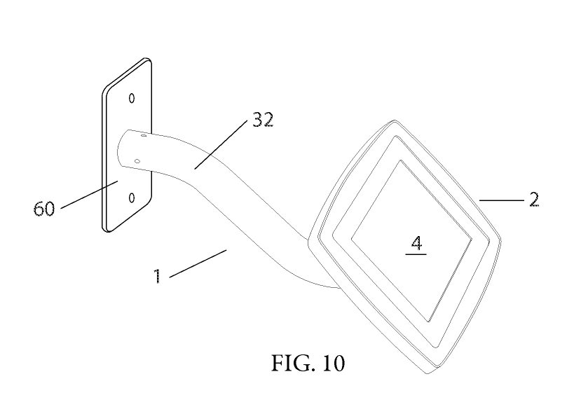

The accompanying drawings show a display stand assembly having a support structure 1 and a device-holding assembly 2 which holds a device 3 with its electronic display 4 exposed (and any device controls which are desired to be exposed). The support structure in this example is for a floor display, but the support structure can be varied depending on where the assembly is to be installed. Two other examples are described herein, namely a table top configuration (see FIG. 8) and a wall mount configuration (see FIG. 10). Obviously other configurations could be adopted, using the principles and main features of the invention.

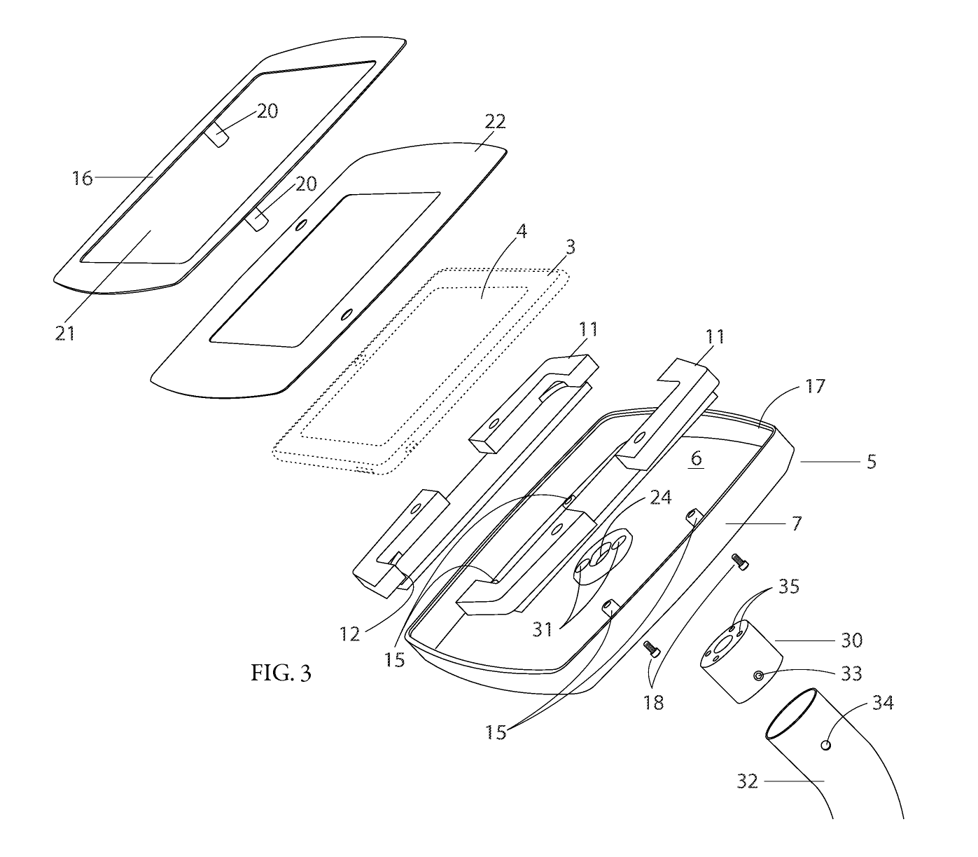

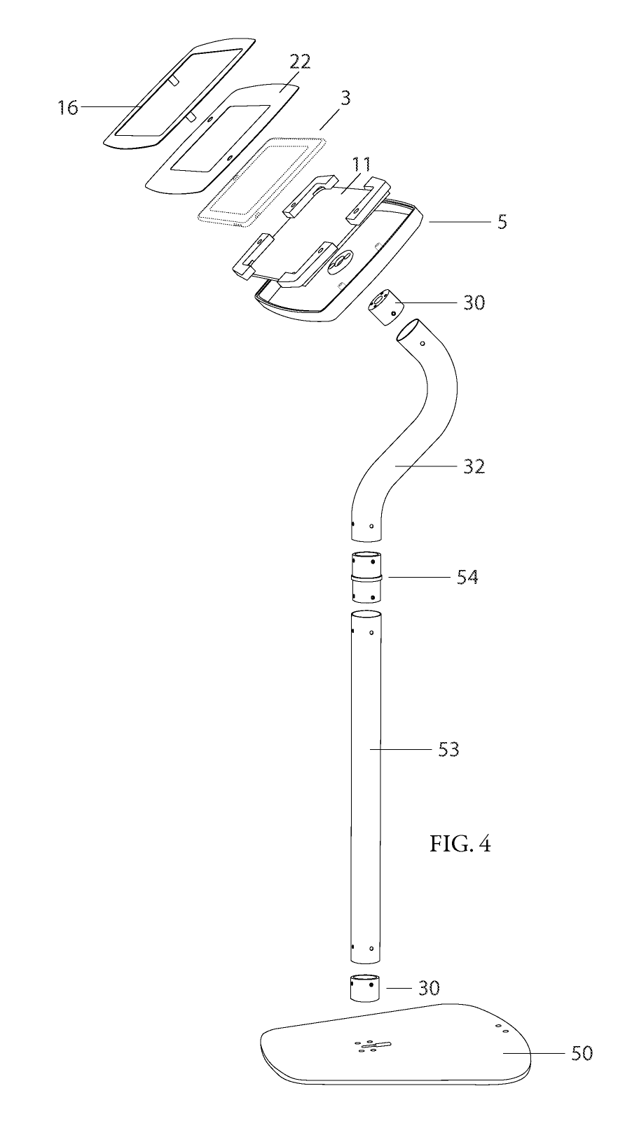

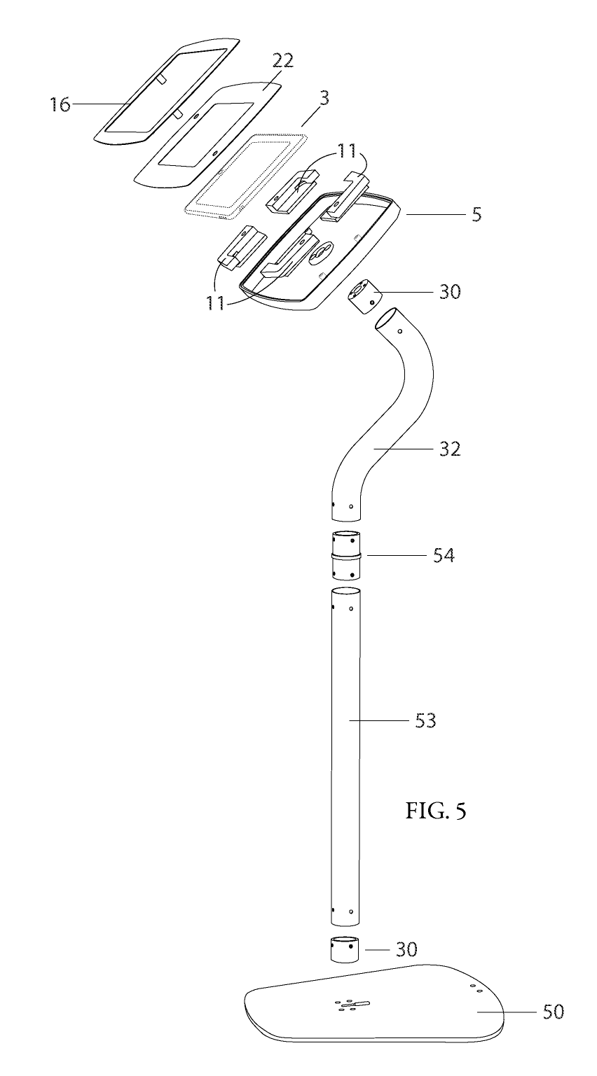

As seen best in FIG. 3, the device-holding assembly 2 includes a housing 5 having a rear surface 6 and surrounding walls 7. The housing defines an insert cavity sized larger than the device, to receive at least one replaceable insert 11 positionable within the insert cavity. In this example, two such inserts 11 and 11′ are illustrated. However, it should be understood that a single insert could be used, as illustrated in FIG. 4, or there could be four inserts as illustrated in FIG. 5 and as described in the provisional application upon which this application is based. Regardless of the number of inserts, the insert(s) provide(s) inner surfaces 12 defining a device cavity, the device cavity being sized to receive the device 3, both in terms of the device's shape and dimensions and in terms of its depth. Devices of different sizes may be used in the display stand assembly by selection of insert(s) defining a device cavity appropriately sized for the selected device.

The insert(s) 11 is/are preferably held in place by pins 15 extending from the rear surface 6 of the housing, engaging corresponding holes in the insert(s).

It is advantageous to use two or four inserts instead of just one, in terms of weight and amount of material used, and therefore production costs, especially for larger display assemblies. Using more than one insert also provides more interior space, which may be required for cabling and any necessary or desired connections to the device.

A face plate 16 sits in a recess 17 of the housing, and is secured to the housing over the insert(s) 11, 11′ and the device 3, by Torx™ security screws 18 or the like, passing from the back of the rear surface 6 through holes in the insert(s) 11 and frame 22 and screwing into studs 20. The studs may have a short male thread on one end which screws into the face plate from the back to sit flush with the front of the face plate, or preferably they are welded in place and ground flush for a smooth outer surface of the face plate. The other ends of the studs have a female threaded opening (not shown) to receive the screws 18. The use of Torx™ security screws or the like is preferred, so that the assembly cannot be dismantled casually by just anyone, a special tool being required to loosen the screws.

The housing and face plate preferably are machined from aluminum, but other sufficiently robust materials obviously could be used. Injection molded plastic is presently being considered, for example.

The face plate 16 has an opening 21 sufficiently large to expose the display area 4 of the device. Thus the face plate 16 itself can act as the desired frame or cover for the device, if the opening 21 is suitably sized for the device and provided with any necessary openings for any permitted access to device controls, volume buttons, camera lenses, etc. However, in a preferred example of the invention, a separate frame 22 is provided, for positioning between the face plate 16 and the device 3. This facilitates using the assembly for different devices, since a kit for any given device can be provided, consisting of the insert(s) 11 and a frame or frames 22 specific to the device, with the face plate 16 being sized for the largest device intended to be accommodated.

As stated previously above, it may be desirable to provide more than one frame for a given device, to provide flexibility as to which features of the device are to be covered and which are to be revealed. Using the Apple iPad as an example, in some applications it may be desirable to have everything covered except the display (possibly with pin-hole access to the home button via a small hole through the face plate and/or frame). In other applications, it may be desirable leave the home button and/or the front camera lens exposed, for example.

For some installations, it may also be necessary or desirable to provide small holes through the housing and/or face plate, to provide access to on/off switches or the like.

The insert(s) 11 must take into account the location of various plugs and peripheral attachments which the device may require, i.e. the inserts must be configured so as not to block any necessary connection points and so as to provide for routing of power cords or other necessary cables. To provide for cable access in a way that is both secure and aesthetic, the support structure 1 is preferably hollow. Metal tubing is therefore preferred. As can be seen in FIG. 3, cabling to or from the device can be routed through a hole 24 in the rear surface 6 of the inside of the housing 5, and thence down through the tubing 32 of the support assembly. The area around the hole is preferably thicker than the rest of the rear surface, for added strength. The connector 30 and any connectors 54 between tubing sections are therefore also not solid, but instead have central openings. A cutout 52 provides for passage of cables from the tubing. In a permanent installation, instead of using the cutout 52, cabling can be routed through a hole in the floor, table top or wall, so that nothing is exposed.

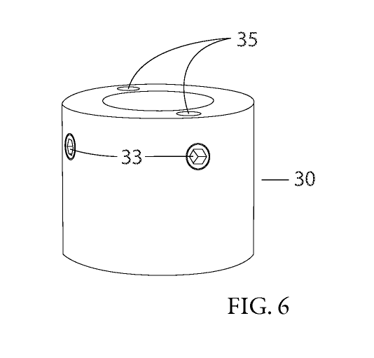

The support structure 1 will now be described in more detail. A connector 30 as shown in FIG. 6, made of machined plastic for example, is secured to the outside of the rear surface 6 of the housing by two screws (not shown) screwed through holes 31 in the plate 25 from inside the housing, into threaded holes 35 in the connector. A generally S-shaped tube 32 slides onto the connector and is secured to it by four set screws 33 through holes 34 in the S-shaped tube screwing into threaded holes in the connector. For convenience of assembly, the set screws are turned in flush to the connector before a connection and then once the tube is in position over the connector, the screws are turned counterclockwise through the holes 34 to fasten the tube in place and add rigidity to the connection. Obviously, other connection means could be used if desired. For anti-theft reasons, however, quick-release connections generally should not be used, unless theft is not a concern.

Since there are four set screws 33 and holes 34 offset from each other by ninety degrees, the device-holding assembly 2 can be oriented in any one of four orientations, including of course either portrait or landscape viewing of the device. Similarly, there are four holes 35 in the connector, affording an alternative means of orienting the device-holding assembly.

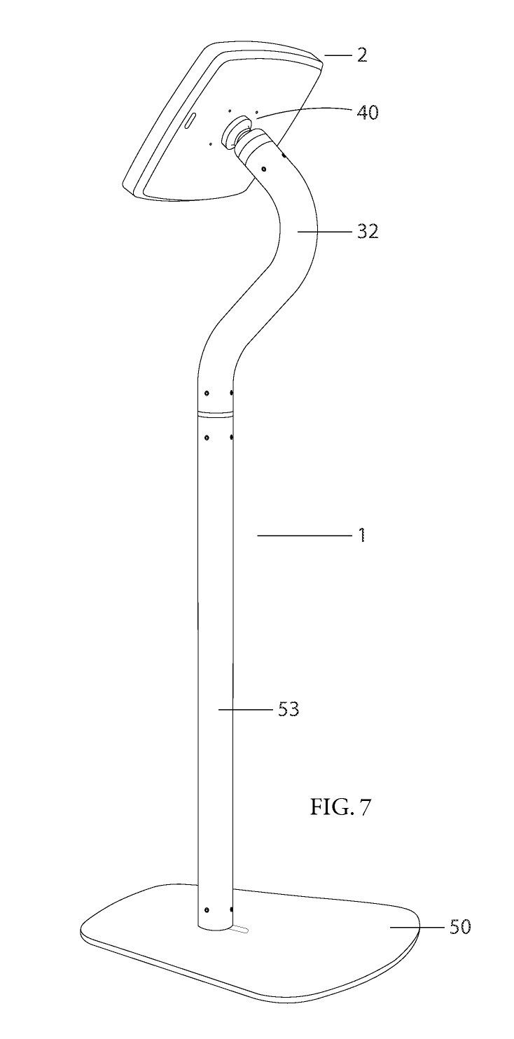

As an alternative, as shown in FIG. 7, the connector 30 (not visible in FIG. 7) could be secured to a ball joint assembly 40, and thence to the tube 32, so that the angle of the display could be varied, and/or so that the display could be rotated.

As can be appreciated from the drawings, the S-shape of the tube 32 positions the housing at an optimum viewing angle, and also puts the center of gravity of the device generally over the support assembly to reduce any tipping potential. (Of course it will generally be preferable to secure the device to the floor or table top in any event.)

For a table top version of the assembly, as shown in FIG. 8 a base plate 50 is secured to the bottom of the S-shaped tube 32, in the same manner as the housing is connected, i.e. by using a connector identical to the connector 30. Four screws from under the base plate thread into the connector, and the bottom of the tube 32 slides over the connector and is secured thereto in the same manner as described above for the connector. For easier storage and portability, the base plate can comprise two separate pieces, or in one piece as illustrated. In either case, the cutout 52 provides for passage of cables through from beneath and into the connector and tubes.

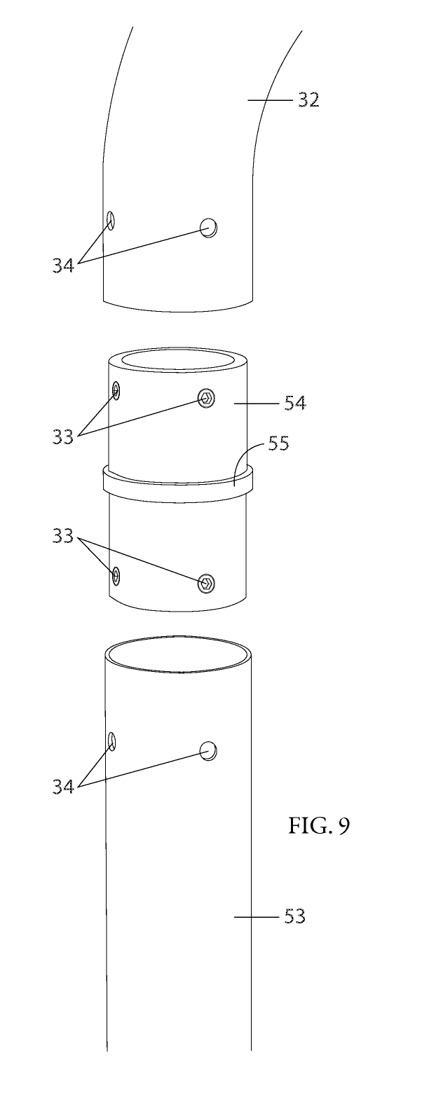

For a floor version of the assembly, an extension tube 53 is inserted between the base plate 50 and the S-shaped tube 32 as shown in FIG. 9. A double-ended connector 54 is used to connect the extension tube to the S-shaped tube, in the same manner as with the connector 30 and the base connector 51. A central flange 55 facilitates assembly, by preventing the connector from falling into the tube. Alternatively, of course a one-piece tube could be used, i.e. extending from the base to the device-holding assembly.

For a wall-mount version of the assembly, the S-shaped tube is connected to a wall mount plate 60, as shown in FIG. 10, securable to a wall.

For any of these configurations, the installation may be either permanent or temporary. For temporary installations, such as at a trade show, it can be seen that the assembly is relatively quick and easy to disassemble, given the proper tools to unscrew the security screws.

It should be clear that the invention need not be constructed exactly as described and illustrated here. A number of possible variations will be apparent to those who are knowledgeable in the field of the invention, and such variations are considered to be within the scope of the invention as defined by the claims which follow, i.e. the invention is not limited to the specific embodiments described and illustrated here.

1. In a display stand assembly for a tablet computer or other device having an electronic display area, where the display stand assembly comprises a support structure and a device-holding assembly attached to the support structure, and where the device-holding assembly is configured to receive and secure the device, the improvement wherein the device-holding assembly comprises:
a housing having a rear surface and surrounding walls extending therefrom, defining an insert cavity sized larger than the device;
at least one replaceable insert positionable within the insert cavity, the insert(s) having inner surfaces defining a device cavity, the device cavity being sized to receive the device; and
a face plate securable to the housing over the insert(s) and device, the face plate having an opening sufficiently large to expose the a desired display area of the device;
whereby devices of different sizes may be used in the display stand assembly by selection of insert(s) defining a device cavity appropriately sized and shaped for the selected device.

2. A display stand assembly as in claim 1, wherein said at least one replaceable insert is a single integral insert.

3. A display stand assembly as in claim 1, wherein said at least one replaceable insert comprises two opposing inserts.

4. A display stand assembly as in claim 1, wherein wherein said at least one replaceable insert comprises four inserts, namely one adjacent each corner of the insert cavity.

5. A display stand assembly as in claim 1, further comprising a frame positioned between the face plate and the housing to overlie the device, the frame also having an opening sufficiently large to expose a desired display area of the device.

6. A display stand assembly as in claim 5, wherein the opening of the face plate is sufficiently large to expose the desired display area of the largest device which could fit within the housing, whereby a kit specific to a smaller device can comprise suitably-configured insert(s) and a frame with an appropriately-sized smaller opening for the device.

7. A display stand assembly as in claim 1, wherein the support structure comprises a first element securable to said rear surface of said housing, and at least one additional element securable to said first element, the selection of said elements providing various configuration options for said display stand assembly.

8. A display stand assembly as in claim 7, wherein one said additional element is a base plate configured to support said device-holding assembly above a generally horizontal surface.

9. A display stand assembly as in claim 8, further comprising at least one extension element between said first element and said base plate, to support said device-holding assembly at a greater distance above a generally horizontal surface than without said extension element.

10. A display stand assembly as in claim 7, wherein one said additional element is a wall-mountable plate configured to support said device-holding assembly extending away from a wall.

11. A display stand assembly as in claim 7, wherein said elements are hollow to permit routing of cables therethrough, to and/or from the device.

12. A display stand assembly as in claim 7, wherein said first element is secured to said housing by a ball joint assembly, whereby the position of said housing relative to said support assembly can be varied.

13. A display stand assembly as in claim 12, wherein said elements and said ball joint assembly are hollow to permit routing of cables therethrough, to and/or from the device.

14. A display stand assembly as in claim 5, wherein the support structure comprises a first element securable to said rear surface of said housing, and at least one additional element securable to said first element, the selection of said elements providing various configuration options for said display stand assembly.

15. A display stand assembly as in claim 14, wherein one said additional element is a base plate configured to support said device-holding assembly above a generally horizontal surface.

16. A display stand assembly as in claim 15, further comprising at least one extension element between said first element and said base plate, to support said device-holding assembly at a greater distance above a generally horizontal surface than without said extension element.

17. A display stand assembly as in claim 14, wherein one said additional element is a wall-mountable plate configured to support said device-holding assembly extending away from a wall.

18. A display stand assembly as in claim 14, wherein said elements are hollow to permit routing of cables therethrough, to and/or from the device.

19. A display stand assembly as in claim 14, wherein said first element is secured to said housing by a ball joint assembly, whereby the position of said housing relative to said support assembly can be varied.

20. A display stand assembly as in claim 19, wherein said elements and said ball joint assembly are hollow to permit routing of cables therethrough, to and/or from the device.
